(19) United States
(12) Patent Application Publication
(10) Pub. No.: US 2021/0094382 A1
(43) Pub. Date: Apr. 1, 2021

(54) VEHICLE HEATING SYSTEM

(71) Applicant: Nor Green Tech Concept AB, Högland (SE)

(72) Inventor: Ola Engman, Umeå (SE)

(21) Appl. No.: 16/968,918

(22) PCT Filed: Aug. 4, 2018
(86) PCT No.: PCT/SE2018/000018

§ 371 Date: Aug. 11, 2020

(30) Foreign Application Priority Data
Aug. 4, 2017 (SE) 1700162-9

(51) Int. Cl. B60H 1/00; B60H 1/22

(52) U.S. Cl. CPC B60H 1/00264; B60H 1/2226; B60H 2001/2256; B60H 2001/2278; B60H 2001/2281

(57) ABSTRACT

A system (1) for heating a vehicle interior comprising at least one subsystem (2) for heat delivery to the vehicle's interior, cab or the like, at least one subsystem (3) for supplying electrical energy to the system (4) for heating, at least one subsystem (5) for controlling the system (1) and at least one subsystem (6) for storing electrical energy (2) so that heat delivery to the vehicle's interior, cab or the like comprises at least one heat delivery device (7). The heat delivery device (7) comprising at least one infra-heater and at least one air flow generating device (8). The said air flow generating device (8) creating an air flow that flows past the infra-heater allowing the airflow to absorb the heat energy which is a by-product of the infra-heater which results in a combination of convection heat and direct infra-heat. The system (1) provides a more even heat dissipation achieving higher efficiency, and that the system's (1) subsystem (6), for storing electric energy, includes at least one accumulator, separated from the other electrical components of the vehicle.

### TECHNICAL FIELD

The present invention relates to a vehicle heating system according to the claims.

### TECHNICAL BACKGROUND AND PRIOR ART

Devices and systems for heating vehicles and the like are previously known in a variety of variants and designs. For example, devices and systems developed using the excess heat from the cooling system in the vehicle to heat the interior of the vehicle such as the vehicle's compartment. This happens, for example, by flowing coolant from the cooling system to a heat pack or the like. A fan creates an airflow through the heat pack, after which the heated air is then inserted into the vehicle's interior or similar. The design has a number of problems. One of the problems is that the engine must be running, or alternatively a diesel/gas heater for the heating system to deliver heat to the vehicle's interior. This entails, for example, major environmental disadvantages. These systems also have other disadvantages.

It is furthermore known to use a variety of types and variants of AC systems that heat or cool the vehicle interior, such as the vehicle's compartment, for example. Even these systems have a number of different problems. For example, the engine must be running to allow the heating system to deliver heat to the vehicle's compartment. The fact that the engine needs to be running when the AC system is driven causes major environmental disadvantages.

It is also known to use different types of compartment heaters and the like. These usually have the problem that they need to be connected to an external power source such as the fixed power grid. Thus, the vehicle must be stationary at an electrical outlet where the passenger compartment heater is used, which implies clear restrictions on the use of these heaters.

Other types of heat release devices are also known in the art. The problem with these is that they usually take electrical energy from the starter batteries for the heat-generating devices used for heating. This causes the energy in the car's accumulators to decrease to a level that is insufficient to start the vehicle. Preferably, in the present system, separate portable/stationary batteries are used or alternatively other power sources.

A number of variants of so-called infrared heaters are known for the purpose of heating the vehicle's interior. For example, DE102013007267A1 describes a device for heating the interior of the vehicle comprising an electric infrared heater and a reflector. The reflector is adapted to direct the infrared heat. The structure of the device differs significantly in relation to the design according to the present patent application.

Even DE102012001460 describes a device intended to be used for heating a vehicle's compartment. The equipment includes an infrared heater and a reflector. The device is located in an air duct so that an air stream in the air duct passes and cools the reflector and the heater. The heated air is then inserted into the vehicle compartment. The design differs to a significant extent from the design in accordance with the present patent application.

In U.S. Pat. No. 3,786,233 is described a variant of a device which is intended to be used to heat a room by means of infra-red heating. The device comprises infrared lamps used for heating. The device further comprises a fan for creating an air flow that cools off the device. The heated airflow is then placed in the vehicle's compartment. The design differs to a significant extent from the design in accordance with the present patent application.

The patent. JPS59213512 describes a variant of a device for heating a vehicle windshield. An infrared heater heats a tube with a mirrored surface and a fan blows out the warm air in the vehicle. The design differs to a significant extent from the design in accordance with the present patent application.

DE10201521882613 describes a variant of a device for heating a vehicle. The device comprises an air heater for heating air in an air duct. A fan is arranged to blow out hot air from the air duct. The design differs to a significant extent from the design in accordance with the present patent application. For example, the device is not a system in accordance with the present patent application.

Even EP1679241 describes a variant of a device for heating the windshield of a vehicle. The design differs to a significant extent from the device in accordance with the present patent application. For example, the device is not intended to heat the compartment in its entirety but only the windshield.

US2016/0167482A1 discloses a variant of a device for heating a vehicle. The device comprises an inverter for heating. The design differs to a significant extent from the design in accordance with the present patent application. For example, the device is not a system in accordance with the present patent application.

U.S. Pat. No. 5,025,130 discloses a variant of a device for heating a vehicle. The device comprises a resistive heater for heating air in an air duct. A fan is arranged to blow out hot air from the air duct. The design differs to a significant extent from the design in accordance with the present patent application. For example, the device is not a system in accordance with the present patent application.

### PURPOSE OF THE INVENTION

The main object of the present invention is to reduce or completely eliminate at least one of the problems mentioned in this patent application. The purpose is achieved with a system according to the claims.

### BRIEF DESCRIPTION OF FIGURES

In the following description of the present invention, reference and references to the following figures will be made. The figures are briefly described in the following figure list.

FIG. 1A schematically shows a system in accordance with the present invention.

FIG. 1B shows schematically the system used in a vehicle.

FIG. 2 shows an example of a heat-generating unit design.

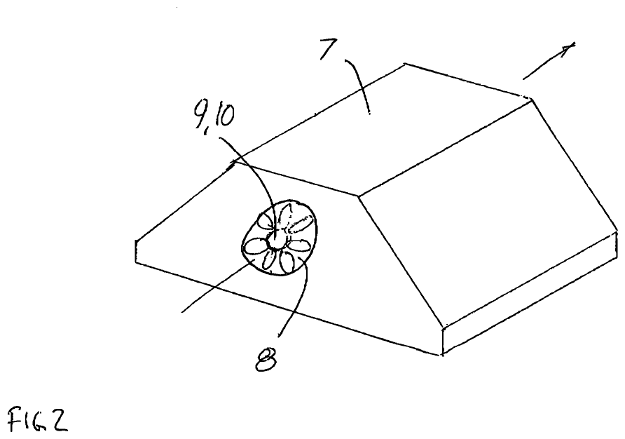

### DETAILED DESCRIPTION OF THE INVENTION

With reference to the figures, a system 1 for heating a vehicle interior is shown. Designed so that while driving the vehicle, the vehicle's electrical system supplies power, and alternatively is charged via the mains during loading and unloading or a combination thereof, via control electronics charging the accumulators in the system so that at rest of the system can heat the vehicle without risking starting problems. The system 1 comprises at least one subsystem 5 for delivering heat to the vehicle interior such as to the vehicle compartment. The system further comprises at least one subsystem 2 for supplying electrical energy to system 1 as well.

Preferably the system 1 has at least one subsystem 3 for storing electrical energy. The system 1 further comprises at least one subsystem 4 for controlling the functions of system 1.

The heat delivery subsystem 2 comprises at least one heat delivery device 6. The heat delivery device 6 is powered by electrical energy provided from the electrical energy subsystem 3.

The design of the heat transfer device 6 may vary within the scope of the present patent application. In the exemplary embodiment, the device comprises at least one housing 7 (housing). The housing 7 is preferably comprised of at least one inlet and at least one outlet for air to and from at least one inner space 8 in the housing 7. At least one heat transfer unit 8 is located in the housing 7. The heat delivery device 6 comprises at least one air flow generating device 9. The air flow generating device 9 comprises in the exemplary embodiment at least one fan 10 that creates a flow of air through or past the heat generating unit 8. In alternative embodiments, the air flow generating device consists of any other appropriate air flow generating apparatus which may lack a housing and/or fan.

In the exemplary embodiment, the heat delivery unit 8 is comprised of at least one infra-heater. The design of the heater may vary within the scope of the present invention.

The heat delivery unit 5, such as preferably an infra-heater, is preferably powered by electrical energy. The electrical energy can be supplied to the heat generating unit from a variety of energy sources or storage devices for electrical energy.

The electrical energy supply system, a subsystem 2 to system 1 is in a first embodiment of the vehicle's electrical system for the supply of electrical energy. The subsystem is preferably used to charge system accumulators.

In alternative embodiments of the system 1, electrical energy is supplied (supplied) from at least one fuel cell or the like. The fuel cell may be a previously known fuel cell or the like.

In additional alternative embodiments, the supply of electrical energy may be via solar cells. The solar cells can be defined as being part of the system or by a separate device or devices.

In further alternative embodiments, the supply of electrical energy can be accomplished via supply of 110 V to 400 AC. Alternatively, another suitable voltage level suitable for the purpose may be used. It may also be conceivable that the system is powered by direct current of varying voltage for the purpose of the appropriate voltage level.

In further alternative embodiments of the present system, the electrical energy may be stored in at least one external electrical energy storage device prior to use in the system.

In another alternative embodiment of the system, the system is used to heat, for example, a truck's interior when the driver of the truck stops and sleeps. The heater is heated with electrical energy from a second battery, belonging to the system, not the vehicle.

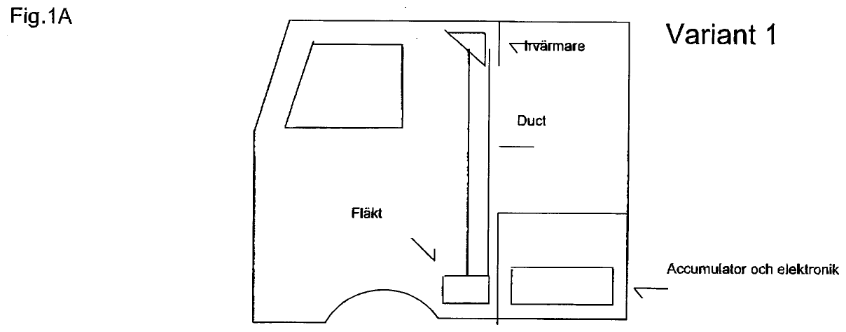

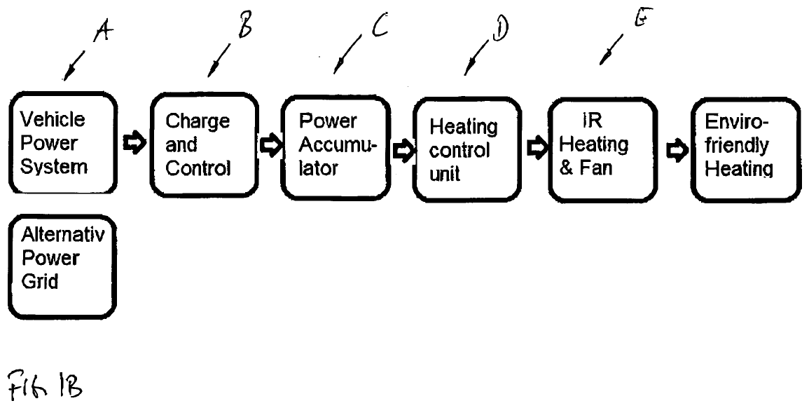

Referring again to FIG. 1B, an exemplary embodiment of the present system will be described in more detail. In this embodiment, the system is a portable system, alternatives are referred to as the portable heating system used in a truck and used to heat the vehicle in connection with, for example, a break/rest stop or during the night. The system is explained step by step with reference to the respective box in the box diagram.

1. The vehicle's electrical system is used in the exemplary embodiment as subsystem 3 to charge the accumulators included in subsystem 3 (FIG. 1B) using modern switch technology. For example, 10-30 volts are used in the system. Alternatively you can have input for other voltages such as 110-400 AC for example. In further alternative embodiments, other voltage levels suitable for the purpose may be used. In alternative embodiments, other solutions such as subsystem 1 (FIG. 1B) are used, for example, with solar panels and/or fuel cell technology (thus increasing the applications).

2. As mentioned in paragraph 1, the electronics are designed so that regardless of voltage, charging and battery status are checked efficiently and safely, i.e. controls the battery level and temperature during the charging phase for safety reasons, but also to ensure charging status regardless of voltage source so that power is available when required (break).

3. The GTC power bank in subsystem 3 (FIG. 1B) is designed so that the capacity is adapted to the need, i.e. a different amount of Amperimeters for different needs, which is determined by the power requirement (size of the space) and the time standing still without adding energy (Accumulators like NiFe when they have high energy density). The GTC Power Bank could also be fuel cell technology.

4. The control unit in subsystem 4 (FIG. 1B) is designed to control temperature, i.e. the climate of the compartment/cab/caravan/restroom/space with several possible applications. By controlling the added power and checking the fan's/fans' speed to provide the selected temperature in the cab. The controller also monitors temperature and battery status. The control unit also includes a timer/clock function.

5. The fan-integrated heater in subsystem 2 is made with highly efficient IR emitting panels that heat the interior of the space, the excess heat that is a by-product of the IR production generated is utilized by the fans and fabrics to direct the air to cool the rear panel, this cooling air is then taken care of and can be piped to targeted areas. This is to achieve the highest possible energy efficiency, while at the same time airflow reaches areas not reached by the IR heat.

### Procedure for Using the System

When using the system, this is moved to at least one space or the like where it will be used. The space can be a variety of spaces where there is a need for heating. The space is in the preferred embodiment of at least one space in a vehicle such as the interior of the vehicle. In a preferred embodiment, the present invention is used in the cab of a vehicle. For example, the cab can be the cab of a truck.

After the system has been moved to the space to be used, the system connects to the electrical system in the space or in close proximity to the space. The system is used in this embodiment in such a way that the system is connected to the vehicle's electrical system. Through the control electronics, the accumulators are loaded into the system when the vehicle is in use. The stored energy in the accumulator unit is used to drive the heat generating unit when the vehicle is not operational so that at rest the system can heat the vehicle without risking starting problems when the vehicle is to be used. In alternative embodiments, it is conceivable that the system is not connected to said one system without the energy being supplied to the system via at least one solar cell, at least one fuel cell or other device that generates electrical energy.

The system's heat-generating device, or devices, is installed in the space. Installation can be done by using a variety of techniques. For example, the heat transfer unit can be hung or laid on a surface. Subsequently, the control system senses temperature in the space and that at least the said heat dissipating unit at temperature in the internal space below a certain predetermined temperature emits heat to air passing through or past the heat generating unit.

In the detailed description of the present invention, design features may be omitted, as will be apparent to those skilled in the art within the scope of the invention. Such obvious design features are included to the extent required for a satisfactory function to be obtained for the present invention.

While some preferred embodiments have been described in greater detail, variations and modifications of the invention within the scope of the invention may become apparent to those skilled in the art, and all such are considered to fall within the scope of the claims.

### ADVANTAGES OF THE INVENTION

With the present invention, a number of advantages are achieved. With the present invention, at least one of the problems disclosed in this patent application is eliminated or minimized. Furthermore, a significantly more environmentally friendly system is created than with existing types of systems. The system also has the advantage that it can be portable and able to be moved between different vehicles/spaces. This combination of heating technologies is considered to be unique and very effective. In addition, heating is quicker due to the fact that the interior stores heat from the IR heater, for example, in and out of the vehicle.

1. A system (1) for heating a vehicle interior comprising at least one subsystem (2) for heat delivery to the vehicle's interior, cab or the like, and that the system (1) comprises at least one subsystem (3) for supplying electrical energy to the system (1) for heating and at least one subsystem (5) for controlling the system (1) and at least one subsystem (4) for storing electrical energy characterized in that the system (1) is portable, and that subsystem (2) for heat delivery to the vehicle's interior, cab or the like comprises at least one heat delivery device (6) comprising at least one infra-heater and at least one air flow generating device (9), said air flow generating device (9) creating an air flow that flows past the infra-heater allowing the airflow to absorb the heat energy that the infra-heater provides, and that subsystem (4), for storing electric energy, includes at least one accumulator separated from the operation of the vehicle's other electrical components.

2. A system (1) according to claim 1 characterized in that the electrical energy is supplied from the vehicle's ordinary electrical system but is intermediately stored in at least one separate accumulator for use during stops.

3. A system (1) according to one of the previous claims characterized in that the electrical energy is provided from at least one fuel cell.

4. A system (1) according to one of the previous claims characterized in that the electrical energy is supplied by the fixed power grid.

5. A method for using systems according to one of claims 1 to 4 characterized in that the system (1) is moved to a space or the like where the system (1) is to be used, after which the system is installed, after which the system is started up and that the control system, operating system senses temperature in the space and controls the provided heat from at least one heat-generating unit.

6. A method in accordance with claim 5 characterized in that the system is used in a space in a vehicle and is connected to the vehicle's electrical system and that while driving the vehicle, the vehicle's electrical system via control electronics will charge the accumulators so that at rest the system can heat the vehicle without risking starting problems.
